(19) United States
(12) Patent Application Publication
(10) Pub. No.: US 2007/0160043 A1
(43) Pub. Date: Jul. 12, 2007

(54) Method, medium, and system encoding and/or decoding audio data

(75) Inventors: Jung-hoe Kim, Yongin-si (KR); Eun-mi Oh, Yongin-si (KR); Ki-hyun Choo, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/651,537

(22) Filed: Jan. 10, 2007

Related U.S. Application Data
(60) Provisional application No. 60/757,880, filed on Jan. 11, 2006.

(30) Foreign Application Priority Data
May 30, 2006 (KR) 10-2006-0049039
Dec. 14, 2006 (KR) 10-2006-0127845

(51) Int. Cl. H04L 12/56

(52) U.S. Cl. 370/389; 370/470

(57) ABSTRACT

An audio data encoding method, medium, and system encoding a header that includes signaling information of audio data and selectively includes signaling information of an extension payload, and encoding the audio data and two or more extension payloads, so that backward compatibility is supported, and a decoder that may recognize the signalling information of such an extension payload.

### CROSS-REFERENCE TO RELATED APPLICATIONS

This application claims the priority of U.S. Provisional Ser. No. 60/757,880, filed on Jan. 11, 2006 in the U.S. Patent Trademark Office, and Korean Patent Application Nos. 10-2006-0049039 and 10-2006-0127845, filed on May 30, 2006 and Dec. 14, 2006, respectively, in the Korean Intellectual Property Office, the disclosures of which are incorporated herein in their entirety by reference.

### BACKGROUND OF THE INVENTION

1. Field of the Invention

One or more embodiments of the present invention relate to encoding and/or decoding of audio data, and more particularly, to a method, medium, and system hierarchically encoding and/or decoding audio data, such as for bit sliced arithmetic coding (BSAC).

2. Description of the Related Art

Both bit sliced arithmetic coding (BSAC) and BSAC extension encoders/decoders are coding formats standardized by the moving picture experts group (MPEG)-4.

BSAC decoders can decode audio data based on a header of the audio data from bit streams generated using the BSAC extension. Herein, a bit stream is defined as including a header and two or more frames, with each frame including audio data and two or more extension payloads. When BSAC decoders restore audio data from the bit stream generated using the BSAC extension, BSAC decoders can support backward compatibility. Here, extension payloads are used to extend audio data such as spectral bandwidth replication (SBR) data for extending the bandwidth of audio data, or for multi channel data for extending one channel of audio data into multi channel audio data.

If the SBR data is combined with audio data, audio data is sampled with a sampling frequency, e.g., Fs/2 kHz, differently from an originally set sampling frequency, e.g., Fs kHz, and then encoded. In this case, the header of the audio data does not have the originally set sampling frequency Fs, but rather the sampling frequency Fs/2, in order to support backward compatibility.

Similarly, if multi channel data is combined with audio data, so that audio data can represent three or more channels, the header of the audio data is for a mono channel or stereo channel in order to support backward compatibility.

With regard to bit streams that can support backward compatibility and are generated using the BSAC extension, BSAC extension decoders cannot recognize the originally set sampling frequency Fs and the extended number of channels of audio data using the header. Therefore, BSAC extension decoders cannot be properly initialized.

### SUMMARY OF THE INVENTION

One or more embodiments of the present invention provide a method, medium, and system encoding audio data so that a decoder can support backward compatibility and recognize signaling information of an extension payload.

One or more embodiments of the present invention also provide a method, medium, and system decoding audio data so that a decoder can support backward compatibility and recognize signaling information of an extension payload.

Additional aspects and/or advantages of the invention will be set forth in part in the description which follows and, in part, will be apparent from the description, or may be learned by practice of the invention.

To achieve the above and/or other aspects and advantages, embodiments of the present invention include an audio data encoding method, including encoding a header that includes signaling information of audio data and selectively includes signaling information of an extension payload, and encoding the audio data and one or more extension payloads.

To achieve the above and/or other aspects and advantages, embodiments of the present invention include an audio data encoding system, including a header encoder to encode a header that includes signaling information of audio data and selectively includes signaling information of an extension payload, and a payload encoder to encode the audio data and one or more extension payloads.

To achieve the above and/or other aspects and advantages, embodiments of the present invention include an audio data decoding method, including decoding a header that includes signaling information of audio data and selectively includes signaling information of an extension payload, and decoding the audio data based on the decoded signaling information of the audio data or the signaling information of the extension payload.

To achieve the above and/or other aspects and advantages, embodiments of the present invention include a medium including computer readable code to control at least one processing element to implement an embodiment of the present invention.

To achieve the above and/or other aspects and advantages, embodiments of the present invention include an audio data decoding system, including a header decoder to decode a header that includes signaling information of audio data and selectively includes signaling information of an extension payload, and a payload decoder to decode the audio data based on the decoded signaling information of the audio data or the signaling information of the extension payload.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an audio data encoding system, according to an embodiment of the present invention;

FIG. 2 illustrates an audio data decoding system, according to an embodiment of the present invention;

FIG. 3 illustrates an audio data decoding method, according to an embodiment of the present invention, where the signaling information of an extension payload is not contained in a header;

FIGS. 4A and 4B together illustrate a syntax indicating headers where the signaling information of an extension payload is contained in the middle of a header, according to an embodiment of the present invention, and where the signaling information of an extension payload is contained at the end of a header, according to another embodiment of the present invention;

FIG. 5 illustrates an audio data decoding method, according to embodiments of the present invention, such as those of FIGS. 4A and 4B; and

FIG. 6 illustrates a diagram explaining such embodiments as FIGS. 3, 4A and 4B.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

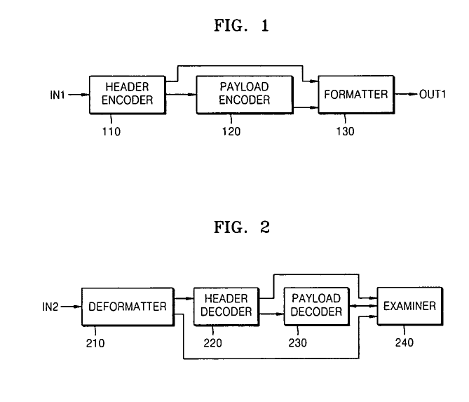

FIG. 1 illustrates an audio data encoding system, according to an embodiment of the present invention. The audio data encoding system may include a header encoder 110, a payload encoder 120, and a formatter 130, for example.

The header encoder 110 may encode a header that contains signaling information of the audio data and selectively contains signaling information of an extension payload.

Here, the audio data may be mono data or stereo data, e.g., for representing multi-channel signal data, and the signaling information of the audio data is information regarding the audio data. For descriptive convenience, it will hereinafter be assumed that the signaling information of the audio data includes information on an encoding or decoding technique, the number of channels (e.g. 2), and a sampling frequency (e.g., 24 kHz) of the audio data.

The extension payload is data for extending the audio data. Examples of the extension payload include spectral bandwidth replication (SBR) data, multi-channel data, and error detection data, for example. The SBR data can be used to extend the bandwidth of the audio data, the multi-channel data can be used to extend a channel of the audio data to be multi-channel, and the error detection data can be used to check a transmission error of the audio data.

The signaling information of the extension payload is information of the extension payload. For descriptive convenience, herein, it will be assumed that the signaling information of the extension payload includes the number of channels (e.g. 5) and a sampling frequency (e.g., 48 kHz) of the audio data when two or more extension payloads are combined with the audio data. In this case, two or more extension payloads including the SBR data and the multi-channel data are combined with the audio data.

The signaling information of the extension payload is selectively contained in the header, unlike the signaling information of the audio data. In detail, the header encoder 110 may encode the header containing the signaling information of the audio data and the signaling information of the extension payload only when the signaling information of the extension payload is input through an input terminal IN1, for example.

The payload encoder 120 may encode the audio data and two or more extension payloads of the audio data. In an embodiment, the payload encoder 120 can hierarchically encode the audio data to hierarchically encode the audio data according to available multiple channels. For example, the payload encoder 120 can encode the audio data and the extension payloads using bit sliced arithmetic coding (BSAC) extension.

The formatter 130 may then generate a bit stream including the encoded header, the encoded audio data, and the encoded extension payloads, and output the bit stream through an output terminal OUT1, for example.

For descriptive convenience, in one embodiment, though not limiting of the present invention, the header does not contain the signaling information of the extension payload, while the header may contain such signaling information of the extension payload according to other embodiments.

In more detail, according to an embodiment, the signaling information of the extension payload may be completely encoded before the header is completely encoded. According to still another embodiment, the header may be completely encoded when the extension payload is completely encoded.

According to still another embodiment, the formatter 130 may output the bit stream including header length information through the output terminal OUT1, for example. The header length information may include the length (i.e., how many bits the header has) of the header.

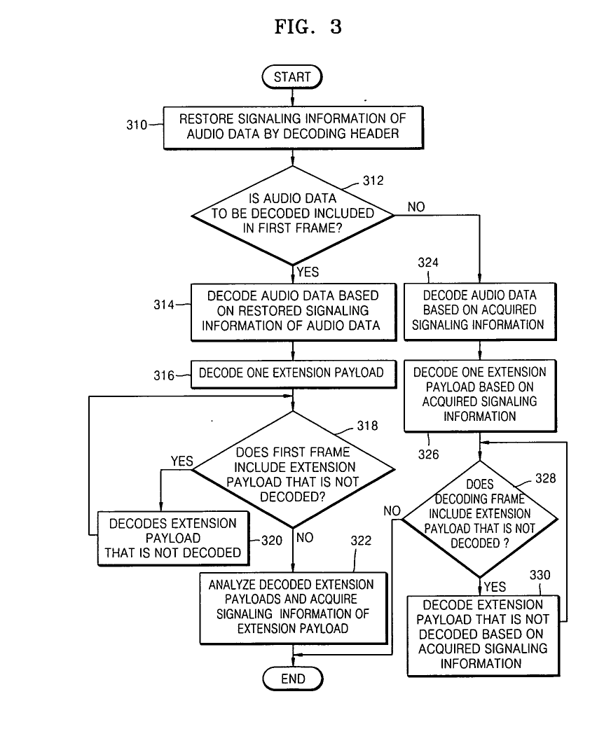

FIG. 2 illustrates an audio data decoding system, according to an embodiment of the present invention. The audio data decoding system may include a deformatter 210, a header decoder 220, a payload decoder 230, and an examiner 240, for example.

Here, the audio data decoding system may be a system hierarchically decoding the audio data, for example. BSAC decoders and BSAC extension decoders are examples of such an audio data decoding system.

In one embodiment, the deformatter 210 may parse a bit stream, e.g., input through an input terminal IN2, and extract a header including an encoded header, encoded audio data, and encoded extension payloads from the bit stream. The bit stream may be the bit stream output through the output terminal OUT1 illustrated in FIG. 1, for example.

The header decoder 220 may decode the header extracted by the deformatter 210, with the header containing signaling information of the audio data and selectively contains signaling information of an extension payload.

If the header includes the signaling information of the extension payload, in one embodiment, the signaling information of the extension payload may be completely decoded before the header is completely decoded according to another embodiment, while the header may be completely decoded when the extension payload is completely decoded, according to still another embodiment.

The payload decoder 230 may further decode the audio data, e.g., extracted by the deformatter 210, based on the audio data or the signaling information of the extension payload, e.g., as decoded by the header decoder 220. In detail, the audio data decoding system, according to an embodiment, is initialized based on the audio data or the signaling information of the extension payload, e.g., decoded by the header decoder 220, and then the payload decoder 230 can decode the audio data.

Thereafter, in an embodiment, the payload decoder 230 can decode the extension payload (e.g., SBR data) extracted by the deformatter 210.

The examiner 240 may examine whether the bit stream (to be specific, a frame being decoded) includes an extension payload (e.g., multi-channel data) that is not decoded. If it is determined that the bit stream includes the non-decoded extension payload, the payload decoder 230 may decode the extension payload. In the same manner, the examiner 240 and the payload decoder 230 may repeat such operations until all extension payloads included in the bit stream (the frame being decoded) are completely decoded, for example.

The operation of the deformatter 210, the header decoder 220, the payload decoder 230, and the examiner 240 will now be described for the occasion when a bit stream generated using the BSAC extension is provided to the BSAC decoder or the BSAC extension decoder. For only descriptive convenience herein, extension payloads combined with the audio data are described as the SBR data and the multi-channel data.

The BSAC decoder may include the deformatter 210, the header decoder 220, and the payload decoder 230, for example. Here, as described, the examiner 240 may not be included in the BSAC decoder.

Thus, the deformatter 210 extracts the encoded header and the encoded audio data from the bit stream, e.g., as input through the input terminal IN2.

The header decoder 220 may decode the extracted header, and the payload decoder 230 may decode the extracted audio data based on the decoded header. The operation of the header decoder 220 and the payload decoder 230, according to differing embodiments will now be described in greater detail.

In one embodiment, when the header does not contain the signaling information of the extension payload, the header decoder 220 may decode the header so that the signaling information of the audio data can be restored. Here, the payload decoder 230 decodes the audio data based on the restored signaling information of the audio data so that backward compatibility is supported.

According to another embodiment, the signaling information of the extension payload must be decoded in order to completely decode the signaling information of the audio data. Here, since the BSAC decoder cannot decode the signaling information of the extension payload, the header decoder 220 cannot properly decode the signaling information of the extension data and the signaling information of the audio data, resulting in the payload decoder 230 not being able to decode the audio data. Thus, with this embodiment, backward compatibility is supported.

According to still another embodiment, if the signaling information of the extension payload is contained in the end of the header, the header decoder 220 can restore the signaling information of the audio data. Therefore, the payload decoder 230 may decode the audio data based on the restored signaling information of the audio data. Thus, again, with this embodiment, backward compatibility is supported.

The operation of a BSAC extension decoder, according to an embodiment of the present invention, will now be described in greater detail.

The BSAC extension decoder may include the deformatter 210, the header decoder 220, the payload decoder 230, and the examiner 240, for example.

The deformatter 210 may extract the encoded header, the encoded audio data, and the encoded audio data from the bit stream input, e.g., through the input terminal IN2, for example.

The operation of the deformatter 210, the header decoder 220, the payload decoder 230, and the examiner 240, in differing embodiments, will be described below in greater detail.

According to an embodiment where the header does not contain the signaling information of the extension payload, the header decoder 220 may decode the header and restores the signaling information of the audio data.

The examiner 240 may examine whether a frame input through the input terminal IN2, for example, is a frame (a first frame) to be decoded first from among frames included in the bit stream.

If the frame input, e.g., through the input terminal IN2, is the first frame, the payload decoder 230 may decode the audio data based on the restored signaling information of the audio data. Although the signaling information of the extension payload is not contained in the header, the payload decoder 230 may decode the audio data and extension payloads (SBR data and multi-channel data) included in the first frame, and analyze the results of the decoding, thereby obtaining the signaling information of the extension payload. Therefore, in this embodiment, the BSAC extension decoder may be properly initialized after decoding the first frame, and the payload decoder 230 may then decode frames other than the first frame from among the frames included in the bit stream based on the obtained signaling information.

Conversely, if the frame input, e.g., through the input terminal IN2, is not the first frame, the payload decoder 230 may decode the audio data based on the obtained signaling information of the extension payload. The payload decoder 230, thus, may decode the SBR data based on the obtained signaling information of the extension payload, and decode the multi-channel data based on the obtained signaling information of the extension payload.

According to another embodiment, the header decoder 220 may decode the header and restore the signaling information of the audio data and the signaling information of the extension payload.

The BSAC extension decoder may be initialized based on the restored signaling information. The payload decoder 230 may decode the audio data based on the restored signaling information of the extension payload and then decode the extension payload (e.g., the SBR data) based on the restored signaling information of the extension payload.

The examiner 240 may examine whether an extension payload (e.g., the multi-channel data) that is not decoded is included in the bit stream (to be specific, a frame being decoded). If such an extension payload is included in the bit stream, the payload decoder 230 may decode the extension payload based on the restored signaling information of the extension payload.

According to still another embodiment, the header decoder 220 may decode the header and restore the signaling information of the audio data and the signaling information of the extension payload.

However, in an embodiment, the header decoder 220 may selectively restore the signaling information of the extension payload. In detail, the header decoder 220 may decode the signaling information of the audio data, and determine whether a remaining header length exceeds a predetermined length. The remaining header length is the length of a portion of the header that has not been decoded, among the total length of the encoded header. The total length of the encoded header is included in header length information. If it is determined that the remaining header length exceeds the predetermined length, the header decoder 220 may recognize header information that is not decoded as the signaling information of the extension payload, and decode the header information that is not decoded so that the header decoder 220 can restore the signaling information of the extension payload. Conversely, if the remaining header length does not exceed the predetermined length, the header decoder 220 may not recognize the header information that has not been decoded as the signaling information of the extension payload, and therefore would not decode the header information that is not decoded, and stop the operation.

The BSAC extension decoder may be initialized based on the restored signaling information. In addition, the payload decoder 230 may decode the audio data based on the restored signaling information of the extension payload and then decode the extension payload (e.g., the SBR data) based on the restored signaling information of the extension payload.

The examiner 240 may examine whether an extension payload (e.g., the multi-channel data) that is not decoded is included in the bit stream (to be specific, a frame being decoded). If such an extension payload is included in the bit stream, the payload decoder 230 may decode the extension payload based on the restored signaling information of the extension payload.

According to an embodiment, when the header does not contain the signaling information of the extension payload, the audio data decoding system may recognize the signaling information of the extension payload after decoding two or more frames. Here, this audio data decoding system may implicitly inform the BSAC extension decoder of the signaling information of the extension payload.

According to another embodiment, the audio data decoding system may recognize the signaling information of the extension payload if the header can be decoded. Here, this audio data decoding system may explicitly inform the BSAC extension decoder of the signaling information of the extension payload. Thus, here, the audio data decoding system may further decode the audio data and the extension payload when the audio data decoding system of the present invention is properly initialized.

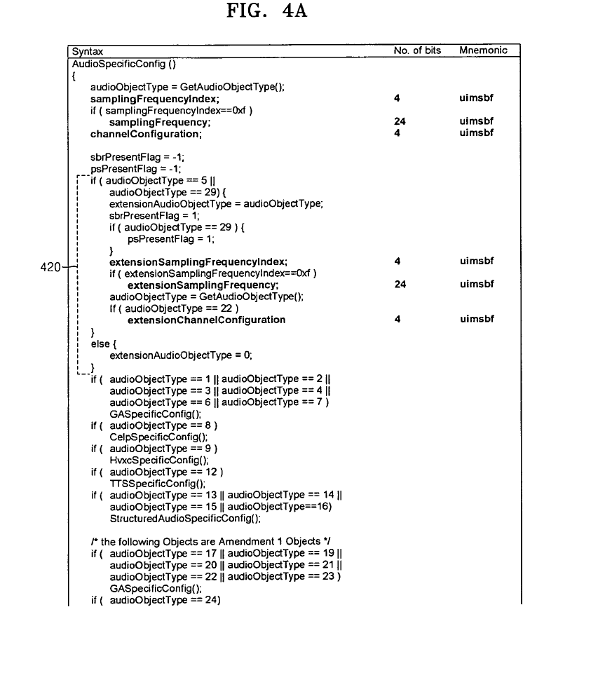

FIG. 3 illustrates an audio data decoding method, e.g., as used by a BSAC extension decoder, according to an embodiment of the present invention, when the signaling information of an extension payload is not contained in a header. The audio data decoding method may include operations 310 through 330, e.g., for backward compatibility and for the BSAC extension decoder to recognize the signaling information of the extension payload.

The signaling information of the audio data may be restored, e.g., by the header decoder 220, by decoding the header, in operation 310. Whether the audio data to be decoded is included in a first frame may further be determined, e.g., by the examiner 240, in operation 312.

If audio data to be decoded is included in the first frame, the audio data may be decoded based on the restored signaling information of the audio data, e.g., by the payload decoder 230, in operation 314.

One extension payload may be decoded, e.g., by the payload decoder 230, in operation 316, and whether the first frame includes an extension payload that is not decoded may be further determined, e.g., by the examiner 240, in operation 318.

If the first frame includes the extension payload that is not decoded, the extension payload that is not decoded may be decoded, e.g., by the payload decoder 230, in operation 320, and operation 318 may be repeated.

If the first frame does not include the extension payload, which is not decoded in operation 318, decoded results of the first frame may be analyzed, e.g., by the payload decoder 230, and the signaling information of the extension payload may be acquired, in operation 322.

If it is determined that the audio data to be decoded is not included in the first frame in operation 312, the audio data may be decoded based on the signaling information acquired in operation 322, e.g., by the payload decoder 230, in operation 324.

One extension payload may be decoded based on the signaling information acquired in operation 322, e.g., by the payload decoder 230, in operation 326, and it may be determined whether a decoding frame includes an extension payload that is not decoded, e.g., by the examiner 240, in operation 328.

If the decoding frame includes the extension payload that is not decoded, the extension payload that is not decoded may be decoded based on the signaling information acquired in operation 322, e.g., by the payload decoder 230, in operation 330, and operation 328 may be repeated.

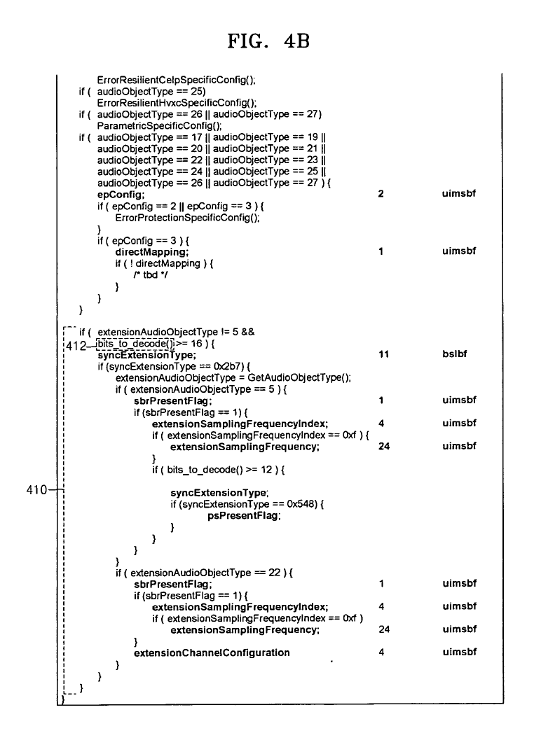

FIGS. 4A and 4B together illustrate a syntax indicating headers where the signaling information of an extension payload is contained in the middle of a header, according to an embodiment of the present invention, and where the signaling information of an extension payload is contained at the end of a header, according to another embodiment of the present invention. The illustrated bottom portion of FIG. 4A should be considered as corresponding to the top portion of FIG. 4B, i.e., though FIGS. 4A and 4B are separately illustrated, they together represent a syntax according to an embodiment of the present invention.

Referring to FIGS. 4A and 4B, a syntax excluding the illustrated portion 410 indicates a header, according to another embodiment of the present invention.

Similarly, a syntax excluding the illustrated portion 420 indicates a header, according to still another embodiment of the present invention.

Here, the illustrated “audioObjectType” indicates what technique is used to encode (or decode) audio data, ‘samplingFrequency;’ indicates a sampling frequency included in the signaling information of the audio data, and ‘channelConfiguration;’ indicates the number of channels included in the signaling information of the audio data.

Similarly, the illustrated ‘extensionSamplingFrequncy;’ indicates a sampling frequency included in the signaling information of an extension payload, and ‘extensionChannelConfiguration;’ indicates the number of channels included in the signaling information of the extension payload.

Further, the illustrated ‘bits_to_decode( )’ portion 412 indicates the length of a remaining header, and ‘sbrPresentFlag’ indicates whether a bit stream includes SBR data.

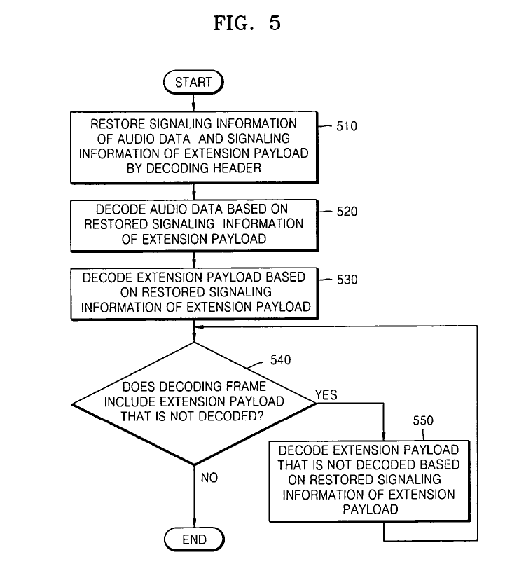

FIG. 5 illustrates an audio data decoding method used by a BSAC extension decoder according to embodiments of the present invention, such as those of FIGS. 4A and 4B. The audio data decoding method may include operations 510 through 550, e.g., for backward compatibility and for the BSAC extension decoder to recognize the signaling information of an extension payload.

The signaling information of the audio data and the signaling information of the extension payload may be restored by decoding a header, e.g., by the header decoder 220, in operation 510. The audio data may be decoded based on the restored signaling information of the extension payload, e.g., by the payload decoder 23, in operation 520.

The extension payload may be decoded based on the restored signaling information of the extension payload, e.g., by the payload decoder 230, in operation 530. Whether a decoding frame includes an extension payload that is not decoded may further be determined, e.g., by the examiner 240, in operation 540.

If the decoding frame includes the extension payload that is not decoded, the extension payload that is not decoded may be decoded based on the restored signaling information of the extension payload, e.g., by the payload decoder 230, in operation 550, and operation 540 may be repeated.

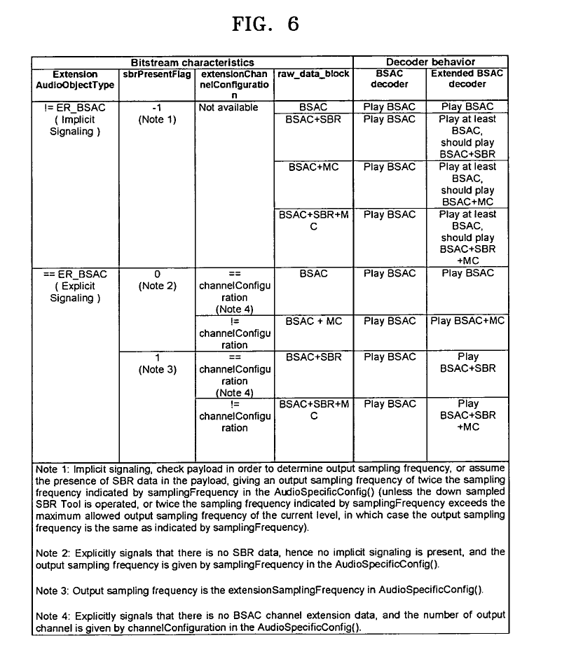

FIG. 6 illustrates a diagram explaining such embodiments as FIGS. 3, 4A and 4B.

Referring to FIG. 6, the illustrated ‘!=ER_BSAC’ is a result obtained when a bit stream (including at least a frame) to be decoded encodes audio data and two or more extension payloads, according to an embodiment of the present invention.

The illustrated ‘==ER_BSAC’ is a result obtained when a bit stream, including at least a frame, to be decoded encodes audio data and two or more extension payloads, according to still another embodiment of the present invention.

Illustrated ‘sbrPresentFlag=−1’ indicates that it is unknown whether a bit stream includes SBR data, illustrated ‘sbrPresentFlag=0’ indicates that a bit stream does not include SBR data, and illustrated ‘sbrPresentFlag=1’ indicates that a bit stream includes SBR data.

In addition, illustrated ‘raw_data_block’ indicates that a payload is included in a bit stream, including at least a frame, illustrated SBR indicates SBR data, and illustrated MC indicates multi-channel data.

When decoder behavior is indicated as the illustrated ‘Play BSAC’, the BSAC decoder, according to an embodiment of the present invention, decodes audio data regardless of whether a bit stream is generated according to one embodiment or another embodiment of the present invention. Accordingly, backward compatibility is supported in both such embodiments.

When the decoder behavior is indicated as the illustrated ‘Play BSAC’, ‘Play at least BSAC, should play BSAC+SBR’, ‘Play at least BSAC, should play BSAC+MC’, and ‘Play at least BSAC, should play BSAC+SBR+MC’, the BSAC extension decoder, according to an embodiment of the present invention, can decode audio data only, or both audio data and two or more extension payloads (e.g., SBR, MC) in order to decode a frame making up the bit stream, e.g., such as generated according to an embodiment of the present invention.

To the contrary, when the decoder behavior is indicated as the illustrated ‘Play BSAC’, ‘Play BSAC+MC’, ‘Play BSAC+SBR’, and ‘Play BSAC+SBR+MC’, the BSAC extension decoder may decode all bit streams, e.g., such as those generated according to an embodiment of the present invention, when the BSAC extension decoder is properly initialized.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

According to a method, medium, and system encoding and/or decoding audio data, according to an embodiment of the present invention, backward compatibility is supported and a decoder can recognize signalling information of an extension payload. Therefore, a terminal can fully restore, using BSAC, audio data from a bit stream generated by using a BSAC extension, and a properly initialised terminal can decode, using a BSAC extension, a bit stream generated by using a BSAC extension, thereby providing improved quality of sound. Thus, in differing embodiments, audio data can be more efficiently encoded, transmitted, and decoded.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An audio data encoding method, comprising:
encoding a header that includes signaling information of audio data and selectively includes signaling information of an extension payload; and
encoding the audio data and one or more extension payloads.

2. The audio data encoding method of claim 1, wherein the signaling information of the extension payload is completely encoded before the header is completely encoded.

3. The audio data encoding method of claim 2, wherein the audio data is hierarchically encoded, and the signaling information of the extension payload includes information on a number of channels represented by the hierarchical encoding.

4. The audio data encoding method of claim 1, wherein the header is completely encoded when the signaling information of the extension payload is completely encoded.

5. The audio data encoding method of claim 4, further comprising:
transmitting encoded results of the encoding of the header and the encoding of the audio data with header length information.

6. The audio data encoding method of claim 4, wherein the audio data is hierarchically encoded, the extension payload is spectral bandwidth replication (SBR) data, and the signaling information of the extension payload includes information on a sampling frequency and a number of channels represented by the hierarchical encoding.

7. The audio data encoding method of claim 1, wherein the extension payload is channel extension data, SBR data, or error detection data.

8. A medium comprising computer readable code to control at least one processing element to implement the method of claim 1.

9. An audio data encoding system, comprising:
a header encoder to encode a header that includes signaling information of audio data and selectively includes signaling information of an extension payload; and
a payload encoder to encode the audio data and one or more extension payloads.

10. The audio data encoding system of claim 9, wherein the audio data is hierarchically encoded, and the signaling information of the extension payload includes information on a number of channels represented by the hierarchical encoding.

11. An audio data decoding method, comprising:
decoding a header that includes signaling information of audio data and selectively includes signaling information of an extension payload; and
decoding the audio data based on the decoded signaling information of the audio data or the signaling information of the extension payload.

12. The audio data decoding method of claim 11, further comprising:
decoding the audio data and the extension payload based on signaling information acquired by analyzing a result of a decoding of a first frame.

13. The audio data decoding method of claim 11, wherein the signaling information of the extension payload is completely decoded before the header is completely decoded.

14. The audio data decoding method of claim 13, wherein the audio data is hierarchically decoded, and the signaling information of the extension payload includes information on a number of channels represented by the hierarchical encoding.

15. The audio data decoding method of claim 11, wherein the header is completely decoded when the signaling information of the extension payload is completely decoded.

16. The audio data decoding method of claim 15, wherein the decoding of the header comprises:
decoding the signaling information of the audio data; and
decoding the signaling information of the extension payload if it is determined that a remaining header length exceeds a predetermined length.

17. The audio data decoding method of claim 15, wherein the audio data is hierarchically decoded, the extension payload is SBR data, and the signaling information of the extension payload includes information on a sampling frequency and a number of channels represented by the hierarchical encoding.

18. The audio data decoding method of claim 11, further comprising:
decoding the extension payload based on the decoded signaling information of the extension payload.

19. The audio data decoding method of claim 11, wherein the extension payload is channel extension data, SBR data, or error detection data.

20. A medium comprising computer readable code to control at least one processing element to implement the method of claim 11.

21. An audio data decoding system, comprising:
a header decoder to decode a header that includes signaling information of audio data and selectively includes signaling information of an extension payload; and
a payload decoder to decode the audio data based on the decoded signaling information of the audio data or the signaling information of the extension payload.

22. The audio data decoding system of claim 21, wherein the audio data is hierarchically decoded, and the signaling information of the extension payload includes information on a number of channels represented by the hierarchical decoding.
